(19) United States
(12) Patent Application Publication
(10) Pub. No.: US 2022/0089198 A1
(43) Pub. Date: Mar. 24, 2022

(54) INSULATING PANELS FOR RAILCARS

(71) Applicant: TRINITY NORTH AMERICAN FREIGHT CAR, INC., Dallas, TX (US)

(72) Inventors: Suman Gachhadar, Frisco, TX (US); Fernando Cardenas Miranda, Zapopan (MX)

(21) Appl. No.: 17/477,879

(22) Filed: Sep. 17, 2021

Related U.S. Application Data
(60) Provisional application No. 63/080,421, filed on Sep. 18, 2020.

(51) Int. Cl. B61D 17/18; B32B 5/02; B32B 5/18; B32B 5/24; B32B 5/26; B32B 3/06

(52) U.S. Cl. CPC B61D 17/18; B32B 5/02; B32B 5/18; B32B 5/245; B32B 5/26; B32B 2260/046; B32B 2307/304; B32B 2605/10; B32B 2262/101; B32B 2260/021; B32B 3/06

(57) ABSTRACT

A system for insulating a railcar is disclosed. The system includes a roof, front, back, left, and right side portions. Each portion includes a plurality of insulating panels. The insulating panels are coupled to an inner surface of the railcar. The insulating panels are joined to each other by a plurality of joints. Each insulating panel includes an outer layer with a first material and a first thickness, an insulating layer with a second material and a second thickness, and an inner layer with a third material and a third thickness. Each of the first and the third material comprises a fiberglass reinforced plastic or a vinyl. The second material comprises a foam or a fibrous material. The insulating layer is positioned between the inner layer and the outer layer. The inner layer has one or more spacings to house one or more bars with a fourth material, comprising steel.

### TECHNICAL FIELD

This disclosure relates generally to railcars and, more particularly, to insulating panels for railcars.

### BACKGROUND

Shipping and transporting certain commodities sometimes require a temperature controlled atmosphere to protect and control their quality. Various types of commodity railcars have been devised over the years to facilitate shipment of such certain commodities. Some examples of these commodity railcars include refrigerated box railcars, insulated box railcars, shipping railcars, shipping containers, over-the-road box trucks, vans, trailers, etc. Insulated transport railcars are typically designed for this explicit purpose and therefore are typically more expensive and less available than other types of commodity railcars. Also, it may be difficult and expensive to maintain and repair the insulated transport railcars. Further, since they have a limited purpose, they may sit idle at times when they are not needed, which leads to additional maintenance costs.

Commodity railcars are usually built as either insulated or non-insulated. Commodity railcars are not usually changed from one to the other due to expenses of materials and labor. For insulated commodity railcars, many times the insulation becomes part of the structural integrity of the commodity railcar, making conversion between insulated and uninsulated impractical. Furthermore, the insulation structures in the insulated commodity railcars must withstand some portion of the structural loads.

Performance of insulated railcars typically decreases over a short period of time, such as a few years, due to deterioration of the insulating material's performance. Usually, the insulation properties are achieved by the use of a foam material. The foam material absorbs moisture over time, which leads to decreasing the insulating value and hence to decreasing the overall thermal performance of the insulated railcar. In conventional insulated railcars, the foam insulation is an integral part of the design, making it prohibitively expensive and time consuming to replace. In such cases, either the poor performance is tolerated, or the container is scrapped.

### SUMMARY

To address the foregoing problems, systems and methods are disclosed herein for insulating railcars which are initially not insulated. In some cases, these techniques can apply to vans, box trucks, over-the-road trailers, shipping containers, etc. The present disclosure provides a solution to improve the current insulating systems for railcars. The disclosed insulating system includes a plurality of insulating panels. The insulating panels are formed to prevent air leakage and improve the thermal performance of the railcar. The layers of the insulating panel may be constructed of various materials to create an insulating panel that meets structural, thermal, and cost requirements of the insulating system. The insulating panels are exchangeable, thus, one or more currently placed insulating panels may be exchanged with one or more new insulating panels at a desired time to maintain the desired temperature and humidity in the interior of the railcar. The insulating panels may be attached to an interior structure of a railcar by various methods, such as using adhesive materials, fasteners, clamps, caulks, etc. Mechanical fastening may allow easier removal to repurpose the commodity railcar and potentially allow the insulating system to be reusable in another commodity railcar if desired. It also allows easy removal and replacement to upgrade the performance of the insulating system, such as when an aged insulating panel has absorbed moisture, decreasing its insulating performance, or to increase the thermal performance of the railcar for use for a different commodity.

Several embodiments are elaborated in this disclosure. In accordance with a particular embodiments, a system for insulating a railcar is disclosed. The system includes a roof portion including a first set of insulating panels, where the roof portion is coupled to an inner surface of a roof of the railcar. The system further includes front and back portions including a second set of insulating panels, where the front and back portions are coupled to inner surfaces of a front end and a back end of the railcar, respectively. The system further includes left and right side portions including a third set of insulating panels, where the left and right side portions are coupled to inner surfaces of a left side and a right side of the railcar, respectively. The first, the second, and the third set of insulating panels are joined to each other by a plurality of joints.

Each insulating panel from the first, the second, and the third set of insulating panels includes an outer layer, an insulating layer, and an inner layer. The outer layer comprises a first material with a first thickness. The insulating layer comprises a second material with a second thickness. The inner layer comprises a third material with a third thickness. The inner layer includes one or more spacings to house one or more bars with a fourth material. The insulating layer is positioned between the inner layer and the outer layer.

In accordance with particular embodiments, a method for insulating a railcar is disclosed. The method includes installing a first set of insulating panels to a roof of the railcar. The first set of insulating panels is coupled to an inner surface of the roof of the railcar. The method further includes installing a second set of insulating panels to a front end and a back end of the railcar. The second set of insulating panels is coupled to inner surfaces of the front end and the back end of the railcar. The method further includes connecting the first set of insulating panels to the second set of insulating panels by a plurality of joints. The method further includes installing a third set of insulating panels to a left side and a right side of the railcar. The third set of insulating panels is coupled to inner surfaces of the left side and the right side of the railcar. The method further includes connecting the first set and the second set of insulating panels to the third set of insulating panels by a plurality of joints.

Each insulating panel from the first, the second, and the third set of insulating panels comprises an outer layer comprising a first material with a first thickness; an insulating layer comprising a second material with a second thickness; and an inner layer comprising a third material with a third thickness. The inner layer having one or more spacings to house one or more bars with a fourth material. The insulating layer is positioned between the inner layer and the outer layer.

Technical advantages of particular embodiments disclosed herein may include or embody systems and methods for insulating a railcar with a plurality of insulating panels. Disclosed herein are various embodiments of insulating panel systems for railcars that provide several technical advantages. The disclosed insulating system provides a flexibility to be applied to any type of railcars with any dimensions. For example, the disclosed insulating system is easily modifiable to accommodate a railcar with a 50 feet length, a 10 feet height, and a 5 feet width. The design of the insulating panels allows sections to be added or subtracted to accommodate a desired length for a particular commodity railcar. It also allows the heights of the insulating panels to be easily manufactured to a desired size. Further, the design of the insulating panels allows the thickness of the insulating panels to be various thicknesses to satisfy the desired thermal performance of the railcar. The flexibility of the insulating panels allows each insulating panel to conform to any form of edges, corners, and surfaces. For example, the insulating panels may be formed to conform to sharp, curved, and angled edges. In another example, the insulating panels may be formed to conform to curved, cambered, and angled corners. In another example, the insulating panels may be formed to conform to smooth, rough, curved, and angled surfaces.

The disclosed system provides a practical application of converting an uninsulated railcar into an insulated railcar. The disclosed system may also be applied to an existing aged insulated railcar to improve its thermal performance. By applying the disclosed insulating system to an uninsulated railcar, an insulated railcar may be achieved at less cost with equal to or greater thermal performance of a purpose-built insulated railcar. This may increase the usability of assets that are currently underutilized by adding thermal insulating capability for minimal cost and may reduce to time to prepare a commodity railcar for insulated use compared to manufacturing a specially designed commodity railcar.

Certain embodiments of the present disclosure may include some, all, or none of these advantages. These advantages and other features will be more clearly understood from the following detailed description taken in conjunction with the accompanying drawings and claims.

### BRIEF DESCRIPTION OF THE DRAWINGS

For a more complete understanding of this disclosure, reference is now made to the following brief description, taken in connection with the accompanying drawings and detailed description, wherein like reference numerals represent like parts.

FIG. 1 illustrates an isometric view of an embodiment of an insulating panel system for insulating a railcar;

FIGS. 2A and 2B illustrate a side view and a front end view of an embodiment of an insulating panel system for insulating a railcar, respectively;

FIGS. 3A and 3B illustrate an embodiment of a connection between intermediate insulating panels and an embodiment of a connection between edge insulating panels, respectively;

FIG. 4 illustrates embodiments of connections between edge insulating panels;

FIGS. 5A and 5B illustrate some embodiments of connections between edge insulating panels and trim pieces;

FIGS. 6A and 6B illustrate some embodiments of connections between insulating panels on a roof of a railcar and insulating panels on a side of the railcar; and

FIG. 7 illustrates an example flowchart of a method for insulating a railcar.

### DETAILED DESCRIPTION

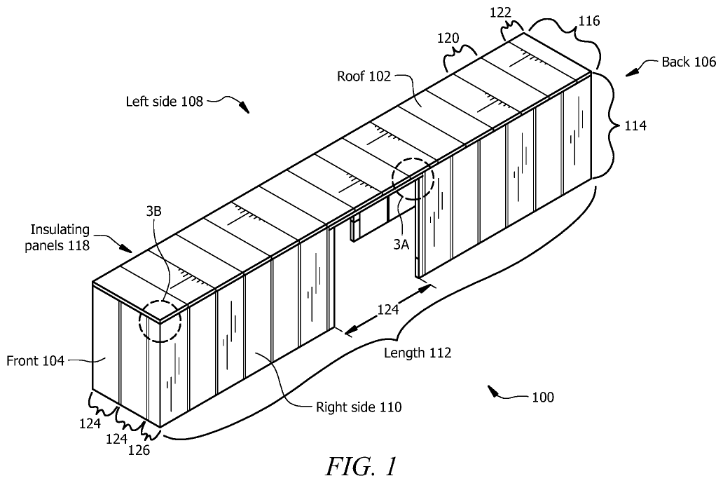

FIG. 1 illustrates an isometric view of an embodiment of an insulating system 100 for insulating a railcar. Examples of railcars and vehicles that may utilize particular embodiments include, but are not limited to, box cars, flat cars, autorack cars, tank cars, vans, trucks, mobile trucks, trailers, hopper cars, coil cars, shipping containers, etc. The insulating system 100 is generally configured for insulating railcars. The insulating system 100 is also configured to withstand some portion of the structural load, cargo, and/or commodity which a railcar is carrying. The insulating system 100 may include any number of insulating panels 118 joined together. The design of the insulating panels 118 allows one or more insulating panels 118 to be added or subtracted to the insulating system 100 in order to accommodate a desired length, width, and height for a particular railcar. As such, the insulating system 100 may be adjusted to accommodate a railcar with any dimension, e.g., by using different numbers of insulating panels 118. In the illustrated embodiment, the insulating panels 118 are joined together to form the insulating system 100 with a length 112, height 114, and width 116. In a first example, the insulating system 100 may be adjusted to accommodate a railcar with a length 112 of 60 feet, a height 114 of 5 feet, and a width 116 of 8 feet. In a second example, the insulating system 100 may be adjusted to accommodate a railcar with the length 112 of 10 feet, a height 114 of 2 feet, and a width 116 of 4 feet.

The insulating system 100 may include one or more of a roof portion 102, a front end portion 104, a back end portion 106, a left side portion 108, a right side portion 110, and a floor portion (not shown). In the illustrated embodiment, the insulating system 100 is shown with the roof portion 102, front portion 104, back portion 106, left side portion 108, and the right side portion 110. Each of these portions may include any number of insulating panels 118 as needed to cover the inner surface of the railcar.

In the illustrated embodiment, the roof portion 102 includes a first set of insulating panels 118. Each insulating panel 118 used in the roof portion 102 is coupled to the inner surface of the roof of the railcar. In some embodiments, each of the insulating panels 118 used in the roof portion 102 may be coupled to the inner surface of the roof of the railcar, for example, by gluing the insulating panel 118 to the inner surface of the roof of the railcar, by using a plurality of fasteners (e.g., mechanical fasteners, clamps, etc.), or by other mechanisms.

In the illustrated embodiment, the front portion 104 and the back portion 106 include a second set of insulating panels 118. Each insulating panel 118 used in the front portion 104 is coupled to the inner surface of the front end of the railcar. Each insulating panel 118 used in the back portion 106 is coupled to the inner surface of the back end of the railcar. In some embodiments, each of the insulating panels 118 used in the front portion 104 and the back portion 106 may be coupled to the inner surface of the front end and the back end of the railcar, respectively, for example, by gluing the insulating panel 118 to the inner surface of the front end and the back end of the railcar, by using a plurality of fasteners (e.g., mechanical fasteners, clamps, etc.), or by other mechanisms.

In the illustrated embodiment, the left side portion 108 and the right side portion 110 include a third plurality of insulating panels 118. Each insulating panel 118 used in the left side portion 108 is coupled to the inner surface of the left side of the railcar. Each insulating panel 118 used in the right side portion 110 is coupled to the inner surface of the right side of the railcar. In some embodiments, each of the insulating panels 118 used in the left side portion 108 and the right side portion 110 may be coupled to the inner surface of the left side and the right side of the railcar, respectively, for example, by gluing the insulating panel 118 to the inner surface of the left side and the right side of the railcar, by using a plurality of fasteners (e.g., mechanical fasteners, clamps, etc.), or by other mechanisms.

Using mechanical fasteners allows for easy removal and replace of an aged insulating panel 118. The insulating panels 118 may be flexible to allow conforming to any surface, such as smooth surfaces, rough surfaces, angled surfaces, and curved surfaces. The insulating panels 118 may be flexible to allow conforming to any edges, such as convex edges, concave edges, concave ramp edges, step edges, bar edges, and angled edges. The insulating panels 118 may be flexible to allow conforming to any corners, such as sharp corners, curved corners, cambered corners, clipped corners, and angled corners. In the illustrated embodiment, the insulating panels 118 are shown with rectangular shapes. In other embodiments, the insulating panels 118 may be constructed with any shape, such as a rectangular, triangle, or polygon (e.g., pentagon, hexagon, etc.).

The insulating panels 118 may be formed to have any desirable dimension to accommodate a railcar with any dimension. In the illustrated embodiment, some of the insulating panels 118 used in the roof portion 102 are formed to have the length 116 and a width 120. However, the insulating panel 118 at the far edge of the roof portion 102 is formed to have the length 116 and a width 122. In the illustrated embodiment, the insulating panels 118 used in the left side portion 108 and the right side portion 110 are formed to have the height 114 and the width 120. In the illustrated embodiment, the insulating panels 118 on the front portion 104 are shown, where two of the insulating panels 118 have a first width 124 and another insulating panel 118 is shown with a second width 126 in order to accommodate the width 116 of the insulating system 100.

In a particular embodiment, the insulating system 100 may also include a floor portion with a plurality of insulating panels 118 (not shown). The floor portion may be placed in a cavity underneath the floor of the railcar; and the insulating panels 118 in the floor portion may be attached to the floor of the railcar by using a plurality of fasteners (e.g., mechanical fasteners, clamps, etc.).

In one embodiment, the insulating panels 118 may be joined to each other by a plurality of joints, such as flat-butt joints, butt-laminate joints, or lap joints. In another embodiment, the insulating panels 118 may be joined to each other by caulking, using adhesive materials. The insulating panels 118 may be formed to accommodate different doorway sizes, window sizes, and air vent sizes. In some examples, the insulating panels 118 may be also be applied to the door of the railcar. In the illustrated embodiment, the insulating panels 118 used in the right side portion 110 are formed to accommodate the doorway with a width 124. The insulating panels 118 may also be formed to accommodate different door types, such as sliding, single-plug, and double-plug. The insulating panels 118 applied to the door of the railcar may be connected to the rest of the insulating panels 118 on the right side portion 110 with a plurality of joints, such as flat-butt joints, butt-laminate joints, and lap joints. In some embodiments, the insulating panels 118 which are applied to the door of the railcar may be designed to cover edges of the door to prevent air leakage and thus increase the thermal performance of the railcar. The insulating panels 118 may also be formed to accommodate different window types, such as sliding, casement, awning, hopper, hung, and double hung.

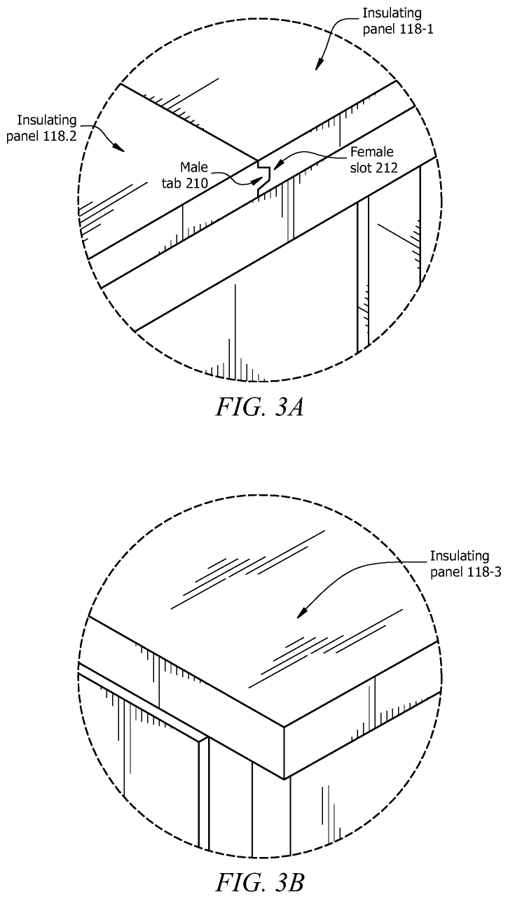

The insulating panels 118 may be coupled to each other in various ways. Various embodiments of coupling or connection between the insulating panels 118 are described in FIGS. 3A and 3B.

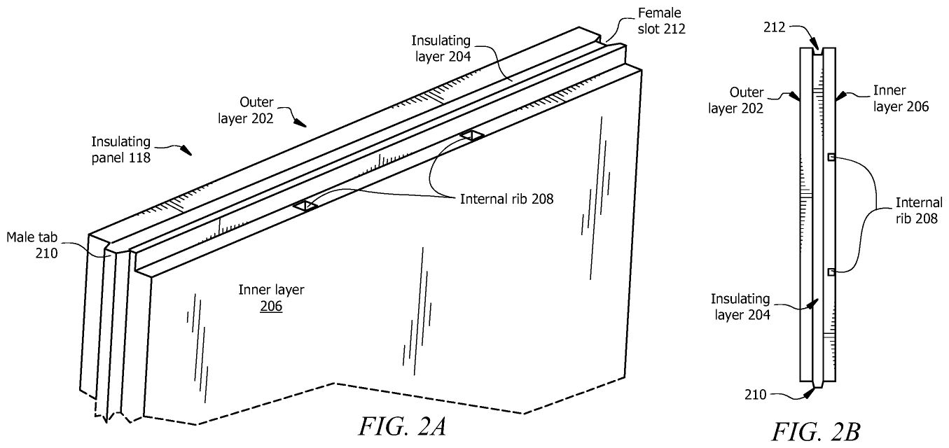

FIGS. 2A and 2B illustrate an isometric view and a side view of an embodiment of the insulating panel 118, respectively. In the illustrated embodiment, the insulating panel 118 includes an outer layer 202, an insulating layer 204, and an inner layer 206. In other embodiments, the insulating panel 118 may include any number of layers as needed to construct the insulating system 100 that meets structural, thermal, and cost requirements of the insulating system 100.

The outer layer 202 is made of a first material with a first thickness. In some examples, the first material may include fiberglass reinforced plastic (FRP), vinyl, plastic alloys, or other fiber composites. In some examples, the first thickness may be any appropriate thickness to be able to support the structural integrity of the insulating panel 118, such as from 0.5 to 10 inches. In some embodiments, the outer layer 202 may be constructed with a particular material and a particular thickness to construct the insulating panel 118 that meets the structural, thermal, and cost requirements of the insulating system 100.

As such, the material and the thickness of the outer layer 202 may be chosen based on one or more of a type of the commodity, a weight of the commodity, the desired temperature of the interior of the railcar, or a size of the railcar. In some embodiments, the outer layer 202 may be constructed from a particular rigid or semi-rigid material with a particular thickness, such that the outer layer 202 is able to sustain impacts from outside world, such as impacts from a forklift carrying the boxes of commodities during loading/unloading the boxes to/from the railcar.

The insulating layer 204 is made of a second material with a second thickness. In some examples, the second material may include foam materials, foam composites, or fibrous materials. In some examples, the second thickness may be any appropriate thickness to be able to support the structural integrity of the insulating panel 118, such as from 0.5 to 10 inches. As such, the material and the thickness of the insulating layer 204 may be chosen based on one or more of the type of the commodity, the weight of the commodity, the desired temperature of the interior of the railcar, and the size of the railcar. In some embodiments, the insulating layer 204 may be constructed from a particular material with a particular thickness to construct the insulating panel 118 that meets the structural, thermal, and cost requirements of the insulating system 100. The insulating layer 204 is positioned between the outer layer 202 and inner layer 206.

In one embodiment, the insulating layer 204 may be attached to the outer layer 202 and the inner layer 206 by gluing using adhesive materials or caulking. In another embodiment, the insulating layer 204 may be attached to the outer layer 202 and the inner layer 206 by hot mill processing.

The inner layer 206 is made of a third material with a third thickness. In some examples, the third material may include fiberglass reinforced plastic (FRP), vinyl, plastic alloys, or other fiber composites. In some examples, the third thickness may be any appropriate thickness to be able to support the structural integrity of the insulating panel 118, such as from 0.5 to 10 inches. In some embodiments, the inner layer 206 may be constructed from a particular material with a particular thickness to construct the insulating panel 118 that meets the structural, thermal, and cost requirements of the insulating system 100. As such, the material and the thickness of the inner layer 206 may be chosen based on one or more of the type of the commodity, the weight of the commodity, the desired temperature of the interior of the railcar, and the size of the railcar. The internal ribs 208 may run through the inner layer 206 along its length/width. The internal ribs 208 may run through the inner layer 206 diagonally. As such, the inner layer 206 may constructed with diagonal spacings.

In some embodiments, the inner layer 206 may be constructed to have one or more spacings to house one or more internal ribs 208 to strengthen the structural integrity of the insulating panel 118. In the illustrated embodiment of FIGS. 2A and 2B, the insulating panel 118 is shown with two internal ribs 208. A person skilled in the art, however, would appreciate that any number of internal ribs 208 may be used to increase the structural integrity of the insulating panel 118 as needed. For example, the internal ribs 208 may be constructed to help the insulating panel 118 to resist pressure from loaded commodity, forklift truck impacts, or other issues. The internal ribs 208 are made of a fourth material with a fourth thickness. In some embodiments, the fourth material may include any metal, metal composites, plastic composites, fiber materials, or wood composites. Some examples of the metal in the fourth material may include steel, iron, or aluminum. Some examples of the metal composites in the fourth material may include steel alloys, iron alloys, and aluminum alloys. Some examples of the plastic composites in the fourth material may include carbon fiber reinforced plastics.

The internal ribs 208 may be varied in their materials, shapes, sizes, lengths, locations, and population density to construct the insulating panel 118 that meets the structural, thermal, and cost requirements of the insulating system 100. In some examples, the internal ribs 208 may be constructed to have any shape, such as a cylinder or rectangular prism. In a particular embodiment, the internal ribs 208 may be constructed to have the same length as the inner layer 206. In other embodiments, same internal rib 208 may run through one or more adjacent insulating panels 118 that are aligned together.

In one embodiment, the inner layer 206 may be constructed such that the spacings for the internal ribs 208 are evenly spread. As such, the locations of the internal ribs 208 are also evenly spread along the length of the inner layer 206. In another embodiment, the inner layer 296 may be constructed such that the spacings for the internal ribs 208 are not evenly spread. As such, the locations of the internal ribs 208 are also spread according to the unevenly spread spacings in the inner layer 206.

The population density of the internal ribs 208 may be varied based on the weight of the commodity of the railcar, the weight of the railcar, and the size of the railcar. In a first example, if the commodity of the railcar is relatively heavy and/or the weight of the railcar is high and/or the size of the railcar is large, the population density of the internal ribs 208 used in each insulating panel 118 may be high, such as five internal ribs 208 per insulating panel 118. In a second example, if the commodity of the railcar is relatively light and/or the weight of the railcar is low and/or the size of the railcar is small, the population density of the internal ribs 208 used in each insulating panel 118 may be low, such as two internal ribs 208 per insulating panel 118. In some cases, the insulating panels 118 which are used in the roof portion 102 may not experience as much impact and pressure from the commodity that the railcar is carrying as the insulating panels 118 which are used in other portions 104, 106, 108, 110, and the floor portion. In such cases, insulating panels 118 with a lesser population density of internal ribs 208 may be used in the roof portion 102. Also, insulating panels 118 with a higher population of internal ribs 208 may be used in the other sections as needed, such as other portions 104, 106, 108, 110, and the floor portion.

In some embodiments, the internal ribs 208 may be placed in other layers, such as the outer layer 202 and/or insulating layer 204. As such the outer layer 202 and/or the insulating layer 204 may be constructed with one or more spacings to house the internal ribs 208. In some embodiments, a first set of internal ribs 208 may be run through a longitudinal axis of one of the layers 202, 204, or 206; a second set of internal ribs 208 may be run through a longitudinal axis of another layer from the layers 202, 204, or 206; and a third set of internal ribs 208 may be run through a longitudinal axis of another layer from the layers 202, 204, or 206. With this approach, an additional strength may be added to the insulating panel 118. In other embodiments the ribs may be run perpendicular to the longitudinal axes.

The thickness of the insulating panel 118 may be the sum of the thickness of the outer layer 202 (i.e., the first thickness), the thickness of the insulating layer 204 (i.e., the second thickness), and the thickness of the inner layer 206 (i.e., the third thickness).

The insulating panel 118 may be designed with a particular thickness based on the desired temperature of the interior of the railcar, the commodity of the railcar, and the size of the railcar. Each of the materials used in the outer layer 202, insulating layer 204, and inner layer 206 may be chosen base on the desired temperature of the interior of the railcar and the commodity of the railcar. In a first example, assume that the desired temperature of the interior of a first railcar is relatively low (e.g., 30 degrees) for a particular commodity. Also assume that the first railcar is relatively large (e.g., 50 feet×10 feet×5 feet). In this case, the thickness and material of each of the layers 202, 204, and 206 are determined to facilitate the desired interior temperature of 30 degrees and to support the structural integrity of the first railcar. For example, the outer layer 202 may be constructed a stable material with a high thickness (e.g., FRP material with a 3 inches thickness); the insulating layer 204 may be constructed with a highly moisture absorbent material with a high thickness (e.g., a foam material with a 4 inches thickness); and the inner layer 206 may be constructed a stable material with a high thickness (e.g., FRP material with a 2 inches thickness).

In a second example, assume that the desired temperature of the interior of a second railcar is relatively low (e.g., 30 degrees) for a particular commodity. Also assume that the second railcar is relatively small (e.g., 10 feet×6 feet×5 feet). In this case, the thickness of each of the layers 202, 204, and 206 may be smaller compared to the first case discussed above, since the interior structure of the second railcar is smaller than the interior structure of the first railcar. For example, the outer layer 202 may be constructed a stable material with a medium to small thickness (e.g., FRP material with a 1 inch thickness); the insulating layer 204 may be constructed with a moisture absorbent material with a medium to small thickness (e.g., a foam material with a 2 inches thickness); and the inner layer 206 may be constructed a stable material with a medium to small thickness (e.g., FRP material with a 0.5 inches thickness).

In some cases, the insulating panels 118 which are used in the roof portion 102 may not experience as much pressure and impact from the commodity that the railcar is carrying as the insulating panels used in other portions 104, 106, 108, 110, and the floor portion. As such, the insulating panels 118 used in the roof portion 102 may be thinner compared to insulating panels 118 used in other portions 104, 106, 108, 110, and the floor portion. Similarly, insulating panels 118 used in the floor portion may experience more pressure and impact from the commodity of the railcar and the forklift that carries the commodity into and out of the railcar. As such, the insulating panels 118 used in the floor portion may be thicker than insulating panels 118 used in other portions 102, 104, 106, 108, and 110.

In the illustrated embodiment, the insulating panel 118 includes a male tab 210 on one edge and a female slot 212 on another edge. The insulating panel 118 may be smooth on its other edges or may have male tab 210/female slot 212 on its other edges. The insulating panels 118 may be joined or coupled together with the use of male tabs 210 and female slots 212. One example of coupling between the intermediate insulating panels 118 is illustrated in FIG. 3A. One example of connection between an insulating panel 118 on a roof 102 of a railcar with insulating panels 118 on front 104 and right side 110 of the railcar is illustrated in FIG. 3B.

FIGS. 3A and 3B illustrate an embodiment of a connection between the intermediate insulating panels 118 and an embodiment of a connection between an insulating panel 118 on a roof 102 of a railcar with insulating panels 118 on front 104 and side 110 of the railcar, respectively. In the illustrated embodiment of FIG. 3A, the first intermediate insulating panel 118-1 is shown with the female slot 212 on its edge; and the second intermediate insulating panel 118-2 is shown with the male tab 210 on its edge. The male tab 210 on the second intermediate insulating panel 118-2 is shaped to accept or fit the female slot 212 on the first intermediate insulating panel 118-1. In some embodiments, the male tabs 210 and the female slots 212 may be formed with different configurations, sizes, shapes, to support the coupling between the insulating panels 118 with each other. In some examples, the male tabs 210 and the female slots 212 may be formed with different variations of curves, concave, convex, angles, and/or any other suitable configurations. The male tabs 210 and female slots 212 of the insulating panels 118 may be formed by any configuration to prevent air leakage, improve thermal performance, and provide stability to the insulating system 100.

In some embodiments, edge insulating panels 118 may be constructed with one, two, or three smooth edges as needed based on their placements. The edge insulating panels 118 may be constructed with smooth edges to prevent air leakage, improve thermal performance, and appearance of the insulating system 100.

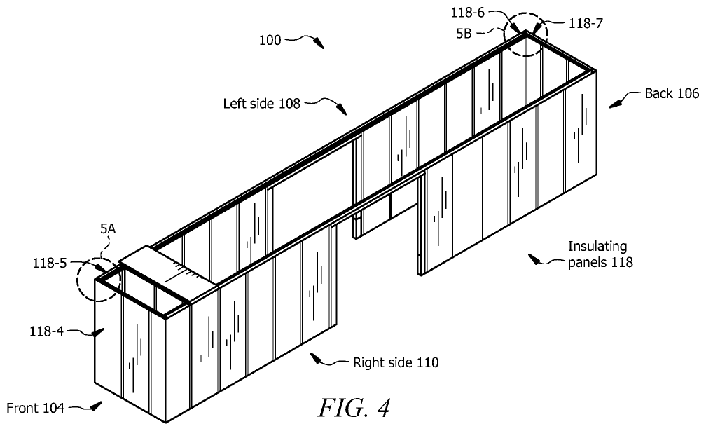

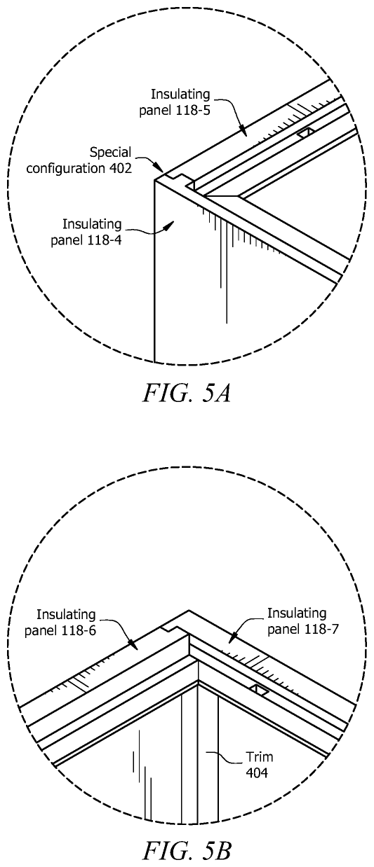

In the illustrated embodiment of FIG. 3B, the edge insulating panel 118-3 has three smooth outboard edges; and a male tab 210/female slot 212 on its other edge in order to connect with its adjacent insulating panel 118. An edge insulating panel 118 may be formed to have a special configuration to accept another edge insulating panel 118. Some example of connections between insulating panels 118 are illustrated in FIG. 4-5B.

FIG. 4 illustrates some embodiments of connections between edge insulating panels 118. Enlarged illustrations of the embodiments of connections between edge insulating panels 118 are shown in FIGS. 5A and 5B. In the illustrated embodiment, the edge insulating panel 118-4 on the front portion 104 is coupled with the edge insulating panel 118-5 on the left side portion 108. An enlarged embodiment of a connection between the edge insulating panel 118-4 and the edge insulating panel 118-5 is shown in FIG. 5A.

Referring to FIG. 5A, the edge insulating panel 118-4 is smooth on its outboard edge and have male tab 210/female slot 212 on its other edge to connect with the rest of the insulating panels 118 in the front end portion 104. The edge insulating panel 118-4 also has a smooth top edge in order to prevent air leakage from the top of the edge insulating panel 118-4. The edge insulating panel 118-4 is constructed with a special configuration 402 on its inside outboard edge to connect with the edge insulating panel 118-5 on the left side portion 108. The edge insulating panel 118-5 is formed to accept the special configuration 402 on the inside outboard edge of the edge insulating panel 118-4. In some embodiments, the special configuration 402 may be formed with different shapes, curves, concave, convex, angles, etc. to prevent air leakage and improve the thermal performance of the insulating system 100.

An enlarged embodiment of a connection between the edge insulating panel 118-6 and the edge insulating panel 118-7 is shown in FIG. 5B. Referring to FIG. 5B, as discussed above, the insulating panels 118 may be attached to each other by a plurality of joints, such as flat-butt joints, butt-laminate joints, or lap joints. As further shown in FIG. 5B, corner protectors or trim pieces 404 may be used to cover the plurality of joints and intersecting seams between the insulating panels 118 to protect the plurality of joints between the insulating panels 118. In the illustrated embodiment, a trim piece 404 is used to cove the intersecting seam between the edge insulating panel 118-6 on the left side portion 108 and the edge insulating panel 118-7 on the back end portion 106. The trim pieces 404 may be used to enhance appearance of the insulating system 100 (see FIG. 4), increase stability and strength to the insulating system 100 (see FIG. 4), and prevent air leakage and thus increase the thermal performance of the insulating system 100 (see FIG. 4). In some embodiments, the trim pieces 404 may be constructed with various materials, such as plastic, plastic composites, metals, metal composites, wood, or wood composites to meet the appearance needs, thermal performance, stability, structural integrity, and cost requirements of the insulating system 100. In some examples, the trim pieces 404 may be attached to the insulating panels 118 using fasteners (e.g., mechanical fasteners, clamps, etc.), adhesive materials, and caulks.

FIGS. 5A and 5B illustrate certain embodiments of connections between edge insulating panels 118. Details of FIGS. 5A and 5B are described above.

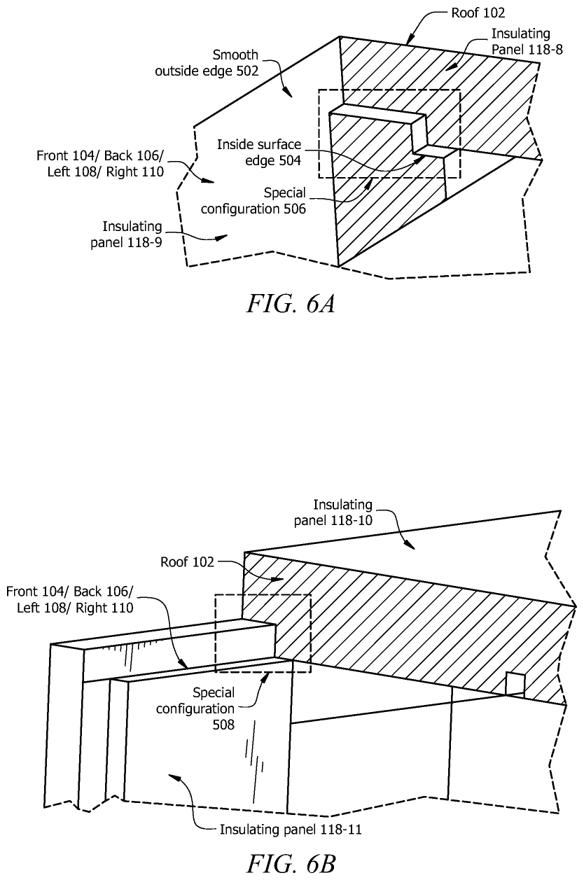

FIGS. 6A and 6B illustrate some embodiments of connections between insulating panels 118 on a roof 102 of a railcar with insulating panels 118 on a side of the railcar. In the illustrated embodiment of FIG. 6A, the edge insulating panel 118-8 on the roof portion 102 is coupled with the edge insulating panel 118-9. The edge insulating panel 118-9 may be on the front end portion 104, back end portion 106, left side portion 108, or right side portion 110. The edge insulating panel 118-8 has a smooth outside edge 502 and a male tab 210/female slot 212 on its other edge to connect with the rest of the insulating panels 118 on the roof portion 102. The edge insulating panel 118-8 is formed to have a special configuration 506 on its inside surface edge 504 to connect with the edge insulating panel 118-9. The edge insulating panel 118-9 is formed to accept the special configuration 506 of the edge insulating panel 118-8. In some embodiments, the special configuration 506 may be formed with different shapes, curves, and angles to prevent air leakage, improve thermal performance, and increase structural integrity of the insulating system 100.

In the illustrated embodiment of FIG. 6B, the intermediate insulating panel 118-10 from the roof portion 102 is coupled with the intermediate insulating panel 118-11. The intermediate insulating panel 118-11 may be on the front end portion 104, back end portion 106, left side portion 108, or right side portion 110. The intermediate insulating panel 118-10 is formed to have a special configuration 508 underneath its outside edge to connect with the intermediate insulating panel 118-11. The intermediate insulating panel 118-11 is formed to accept the special configuration 508 of the intermediate insulating panel 118-10. In some embodiments, the special configuration 508 may be formed with different shapes, curves, and angles to prevent air leakage, improve thermal performance, and increase structural integrity of the insulating system 100.

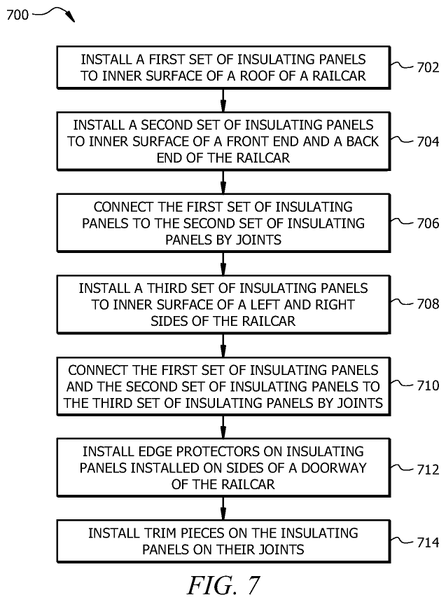

FIG. 7 illustrates an example of a flow chart of a method 700 for insulating a railcar. In some embodiments, a plurality of insulating panels 118 is used for insulating the railcar. Some examples of railcars or vehicles that may utilize particular embodiments include but are not limited to vans, box trucks, over-the-road trailers, or shipping containers. In some embodiments, the method 700 may be applied to an uninsulated railcar in order repurpose the uninsulated railcar and use it for transporting commodities that need to be kept in a temperature controlled environment. In some embodiments, the method 700 may be applied to an aged insulated railcar which thermal performance has deteriorated. The method 700 may include any of the steps 702-714. In some embodiments, the method 700 may be applied to a railcar to construct the insulating system 100 of FIG. 1, where the insulating system 100 includes the roof portion 102, front portion 104, back portion 106, left side portion 108, and right side portion 110. Some aspects of steps 702-714 are described in FIGS. 1-6B; and additional aspects are provided below.

Method 700 begins at step 702 where a first set of insulating panels 118 are installed or attached to the inner surface of a roof of the railcar. In some examples the first set of insulating panels 118 may be attached to the inner surface of the roof of the railcar by using a plurality of fasteners (e.g., mechanical fasteners, or clamps), etc. or by other mechanisms as discussed in FIG. 1. The first set of insulating panels 118 may include any number of insulating panels 118 to accommodate the dimension of the roof of the railcar. For example, if the dimension of the roof of the railcar is 10 feet×2 feet, the first set of insulating panels 118 may include five insulating panels 118 where each of them has a dimension of 2 feet×2 feet. In another example, if the dimension of the roof of the railcar is 11 feet×2 feet, the first set of insulating panels 118 may include five insulating panels 118 where each of them has a dimension of 2 feet×2 feet; and one insulating panel 118 with a dimension of 1 feet×2 feet.

Each intermediate insulating panel 118 from the first set of insulating panels 118 may be constructed with a male tab 210 on one edge and a female slot 212 on another edge. Each intermediate insulating panel 118 is connected to its adjacent insulating panel 118 by fitting its male tab 210 to the female slot 212 of its adjacent insulating panel 118, as described in FIG. 2. The edge insulating panels 118 from the first set of insulating panels 118 may include one, two, or three smooth edges as needed based on their placements.

In step 704, a second set of insulating panels 118 are installed or attached to the inner surface of the front end and the back end of the railcar. In some examples the second set of insulating panels 118 may be attached to the inner surface of the front end and the back end of the railcar by using a plurality of fasteners (e.g., mechanical fasteners or clamps) or by other mechanisms as described in FIG. 1. The second set of insulating panels 118 may include any number of insulating panels 118 to accommodate the dimension of the left and right sides of the railcar, similar to as described above with reference to the first set of insulating panels 118.

In step 706, the first set of insulating panels 118 are connected to the second set of insulating panels 118, as described in FIG. 1. In one example, the first set of insulating panels 118 are connected to the second set of insulating panels 118 by a plurality of joints, such as flat-butt joints, butt-laminate joints, and lap joints. In another example, the first set of insulating panels 118 are connected to the second set of insulating panels 118 by gluing them using adhesive materials, caulks, using fasteners (e.g., mechanical fasteners or clamps), or by other mechanisms. The edge insulating panels 118 on the first and the second set of insulating panels 118 are constructed to have special configurations, such as special configuration 402, 506, 508, and/or any other configurations that prevents air leakage and improve thermal performance and the structural integrity of the railcar, as described in FIGS. 4, 5A, 5B, 6A, and 6B.

In step 708, a third set of insulating panels 118 are installed or attached to the inner surface of the left and right sides of the railcar. In some examples the third set of insulating panels 118 may be attached to the inner surface of the left and right sides of the railcar by using a plurality of fasteners (e.g., mechanical fasteners or clamps) or by other mechanisms as described in FIG. 1. The third set of insulating panels 118 may include any number of insulating panels to accommodate the dimension of the sides of the railcar, similar to as described above with reference to the first set of insulating panels 118. The second set of insulating panels 118 may also accommodate the doorway of the railcar on the one or both sides of the railcar, as described in FIG. 1.

In step 710, the first and the second sets of insulating panels 118 are connected or attached to the third set of insulating panels 118, as described in FIG. 1. In one example, the first and the set of insulating panels 118 are connected to the third set of insulating panels 118 by a plurality of joints, such as flat-butt joints, butt-laminate joints, lap joints, etc. In another example, the first and the set of insulating panels 118 are connected to the third set of insulating panels 118 by gluing them using adhesive materials, caulks, or fasteners (e.g., mechanical fasteners or clamps), or by other mechanisms.

In step 712, edge protectors are installed on the insulating panels 118 installed on both sides of the doorway of the railcar. In some examples, the edge protectors may be constructed from metal, metal composites, plastic, plastic composites, rubber, or rubber composites. In some examples, the edge protectors may be attached to the insulating panels 118 installed on both sides of the doorway by caulking or using adhesive materials.

In step 714, trim pieces 404 are installed on the insulating panels 118 over their joints, as described in FIG. 5B.

In some embodiment, the method 700 may include applying a set of insulating panels 118 to the floor of the railcar, as described in FIG. 1. In some embodiments, applying the insulating panels 118 to different portions 102, 104, 106, 108, 110, and the floor portion may be performed in any appropriate order. One of ordinary skill in the art would appreciate that the insulating panels 118 described in FIGS. 1-6B may be constructed from various materials with various thicknesses to meet the appearance needs, thermal performance, stability, structural integrity, and cost requirements of the insulating system 100.

While several embodiments have been provided in the present disclosure, it should be understood that the disclosed systems and methods might be embodied in many other specific forms without departing from the spirit or scope of the present disclosure. The present examples are to be considered as illustrative and not restrictive, and the intention is not to be limited to the details given herein. For example, the various elements or components may be combined or integrated in another system or certain features may be omitted, or not implemented.

In addition, techniques, systems, subsystems, and methods described and illustrated in the various embodiments as discrete or separate may be combined or integrated with other systems, modules, techniques, or methods without departing from the scope of the present disclosure. Other items shown or discussed as coupled or directly coupled or communicating with each other may be indirectly coupled or communicating through some interface, device, or intermediate component whether electrically, mechanically, or otherwise. Other examples of changes, substitutions, and alterations are ascertainable by one skilled in the art and could be made without departing from the spirit and scope disclosed herein.

To aid the Patent Office, and any readers of any patent issued on this application in interpreting the claims appended hereto, applicants note that they do not intend any of the appended claims to invoke 35 U.S.C. § 112(f) as it exists on the date of filing hereof unless the words “means for” or “step for” are explicitly used in the particular claim.

1. A system for insulating a railcar, comprising:
a roof portion comprising a first set of insulating panels, wherein the roof portion is coupled to an inner surface of a roof of the railcar;
front and back portions comprising a second set of insulating panels, wherein the front and back portions are coupled to inner surfaces of a front end and a back end of the railcar, respectively;
left and right side portions comprising a third set of insulating panels, wherein the left and right side portions are coupled to inner surfaces of a left side and a right side of the railcar, respectively; and
the first set of insulating panels, the second set of insulating panels, and the third set of insulating panels are joined to each other by a plurality of joints;
wherein at least one insulating panel from at least one of the first set of insulating panels, the second set of insulating panels, and the third set of insulating panels comprises:
an outer layer comprising a first material with a first thickness;
an insulating layer comprising a second material with a second thickness; and
an inner layer comprising a third material with a third thickness, the inner layer having one or more spacings to house one or more bars with a fourth material, wherein the insulating layer is positioned between the inner layer and the outer layer.

2. The system of claim 1, further comprising:
a floor portion comprising a fourth set of insulating panels, wherein the floor portion is coupled to inner surfaces of a floor of the railcar.

3. The system of claim 1, wherein:
the first set of insulating panels is coupled to an inner surface of the roof of the railcar by a glue or a first plurality of mechanical fasteners;
the second set of insulating panels is coupled to inner surfaces of the left and right sides of the railcar by a glue or a second plurality of mechanical fasteners; and
the third set of insulating panels is coupled to inner surfaces of the front end and the back end of the railcar by a glue or a third plurality of mechanical fasteners.

4. The system of claim 1, wherein:
each of the first material and the third material comprises a fiberglass reinforced plastic or a vinyl; and
the second material comprises a foam or a fibrous material.

5. The system of claim 1, wherein:
the fourth material comprises steel; and
the one or more bars have the same length as the inner layer.

6. The system of claim 1, wherein a plurality of trim pieces is installed on the plurality of joints connecting the first set of insulating panels, the second set of insulating panels, and the third set of insulating panels.

7. The system of claim 1, wherein:
a dimension and a number of the one or more bars are based at least in part upon at least one of a size of the railcar and a weight of a cargo carried by the railcar.

8. The system of claim 1, wherein a thickness of each insulating panel from among the first plurality of insulating panels, the second set of insulating panels, and the third set of insulating panels is a sum of the first thickness, the second thickness, and the third thickness, wherein the thickness of each insulating panel is based at least in part upon at least one of a desired temperature of the inside of the railcar and a size of the railcar.

9. The system of claim 1, wherein the first set of insulating panels comprises:
a set of intermediate insulating panels, wherein each of the set of intermediate insulating panels comprises a male tap on one edge and a female slot on another edge, wherein at least one of the set of intermediate insulating panels is coupled to an adjacent intermediate insulating panel by fitting its male tap into a female slot of the adjacent insulating panel; and
a set of edge insulating panels, wherein each of the set of edge insulating panels comprises a male tap or a female tap on one edge and a smooth outside edge, wherein at least one of the set of the edge insulating panels is coupled to at least one of the intermediate insulating panels by male taps and female slots.

10. The system of claim 1, wherein the outer layer, the insulating layer, and the inner layer are attached to each other by hot mill processing.

11. A method for insulating a railcar, comprising:
installing a first set of insulating panels to a roof of the railcar, wherein the first set of insulating panels is coupled to an inner surface of the roof of the railcar;
installing a second set of insulating panels to a front end and a back end of the railcar, wherein the second set of insulating panels is coupled to inner surfaces of the front end and the back end of the railcar;
connecting the first set of insulating panels to the second set of insulating panels by a first plurality of joints;
installing a third set of insulating panels to a left side and a right side of the railcar, wherein the third set of insulating panels is coupled to inner surfaces of the left side and the right side of the railcar; and
connecting the first set of insulating panels and the second set of insulating panels to the third set of insulating panels by a second plurality of joints;
wherein at least one insulating panel from at least one of the first set of insulating panels, the second set of insulating panels, and the third set of insulating panels comprises:
an outer layer comprising a first material with a first thickness;
an insulating layer comprising a second material with a second thickness; and
an inner layer comprising a third material with a third thickness, the inner layer having one or more spacings to house one or more bars with a fourth material, wherein the insulating layer is positioned between the inner layer and the outer layer.

12. The method of claim 11, further comprising:
installing a fourth set of insulating panels to a floor of the railcar, wherein the fourth set of insulating panels is coupled to an inner surface of the floor of the railcar.

13. The method of claim 11, wherein:
the first set of insulating panels is coupled to an inner surface of the roof of the railcar by a glue or a first plurality of mechanical fasteners;
the second set of insulating panels is coupled to inner surfaces of the left and right sides of the railcar by a glue or a second plurality of mechanical fasteners; and
the third set of insulating panels is coupled to inner surfaces of the front end and the back end of the railcar by a glue or a third plurality of mechanical fasteners.

14. The method of claim 11, wherein:
each of the first material and the third material comprises a fiberglass reinforced plastic or a vinyl; and
the second material comprises a foam or a fibrous material.

15. The method of claim 11, wherein:
the fourth material comprises steel; and
the one or more bars have the same length as the inner layer.

16. The method of claim 11, wherein a plurality of trim pieces is installed on the second plurality of joints connecting the first set of insulating panels, the second set of insulating panels, and the third set of insulating panels.

17. The method of claim 11, wherein:
a dimension and a number of the one or more bars are based at least in part upon at least one of a size of the railcar and a weight of a cargo carried by the railcar.

18. The method of claim 11, wherein a thickness of each insulating panel from among the first plurality of insulating panels, the second set of insulating panels, and the third set of insulating panels is a sum of the first thickness, the second thickness, and the third thickness, wherein the thickness of the each insulating panel is based at least in part upon at least one of a desired temperature of the inside of the railcar and a size of the railcar.

19. The method of claim 11, wherein the first set of insulating panels comprises:
a set of intermediate insulating panels, wherein each of the set of intermediate insulating panels comprises a male tap on one edge and a female slot on another edge, wherein at least one of the set of intermediate insulating panels is coupled to an adjacent intermediate insulating panel by fitting its male tap into a female slot of the adjacent insulating panel; and
a set of edge insulating panels, wherein each of the set of edge insulating panels comprises a male tap or a female tap on one edge and a smooth outside edge, wherein at least one of the set of the edge insulating panels is coupled to at least one of the intermediate insulating panels by male taps and female slots.

20. The method of claim 11, wherein the outer layer, the insulating layer, and the inner layer are attached to each other by hot mill processing.
